(19) United States
(12) Patent Application Publication
(10) Pub. No.: US 2026/0371077 A1
(43) Pub. Date: Nov. 19, 2026

(54) IDENTITY KEY DISTRIBUTION IN LARGE NETWORKS

(71) Applicant: Cisco Technology, Inc., San Jose, CA (US)

(72) Inventors: Federico Lovison, Fontanelle (IT); Domenico Ficara, Essertines-sur-Yverdon (CH); Jerome Henry, Pittsboro, NC (US); Javier Contreras, Barcelona (ES); Ugo Mario Campiglio, Morges (CH)

(21) Appl. No.: 19/677,150

(22) Filed: May 14, 2026

Related U.S. Application Data
(60) Provisional application No. 63/805,926, filed on May 14, 2025.

(51) Int. Cl. H04W 12/0431; H04W 12/02; H04W 84/12

(52) U.S. Cl. CPC H04W 12/0431; H04W 12/02; H04W 84/12

(57) ABSTRACT

Identity key distribution in large networks may be provided. A station may associate with a first Access Point (AP). The station may identity key information associated with each of one or more neighbor APs from the first AP over a protected connection. The station may receive a privacy beacon transmitted by a second AP of the one or more neighboring APs, the privacy beacon including an obfuscated identifier. The station may identify the second AP based on the obfuscated identifier and the identity key information associated with the second AP.

### RELATED APPLICATION

This application claims the benefit of U.S. Provisional Application No. 63/805,926, filed May 14, 2025, which is incorporated herein by reference.

### TECHNICAL FIELD

The present disclosure relates generally to identity key distribution in large networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various implementations of the present disclosure. In the drawings:

FIG. 1 is a block diagram of an operating environment for identity key distribution in large networks;

FIG. 2 is a flow chart of a method for identity key distribution in large networks; and

FIG. 3 is a block diagram of a computing device.

### DETAILED DESCRIPTION

### OVERVIEW

Identity key distribution in large networks may be provided. A station may associate with a first Access Point (AP). The station may identity key information associated with each of one or more neighbor APs from the first AP over a protected connection. The station may receive a privacy beacon transmitted by a second AP of the one or more neighboring APs, the privacy beacon including an obfuscated identifier. The station may identify the second AP based on the obfuscated identifier and the identity key information associated with the second AP.

Both the foregoing overview and the following example implementations are examples and explanatory only and should not be considered to restrict the disclosure’s scope, as described and claimed. Furthermore, features and/or variations may be provided in addition to those described. For example, implementations of the disclosure may be directed to various feature combinations and sub-combinations described in the example implementations.

### EXAMPLE IMPLEMENTATIONS

The following detailed description refers to the accompanying drawings. Wherever possible, the same reference numbers are used in the drawings and the following description to refer to the same or similar elements. While implementations of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11bi defines a mode called Basic Service Set (BSS) BSS Privacy Enhancement (BPE) where an Access Point (AP) may obfuscate its over-the-air parameters. This may be done to add AP privacy to station privacy defined in Client Privacy Enhancement (CPE), thus obfuscating AP’s presence and parameters from eavesdropper. In BPE mode, the AP rotates its Media Access Control (MAC) address at intervals. The AP may not send regular beacons and may not answer to probe requests. However, the AP may send privacy beacons containing an address of the AP (also referred to as address2) that rotates along epoch intervals. A timestamp in the privacy beacon may be pseudo-randomized and the frame body may be encrypted. In order to decrypt the frame body, a station may need to possess an identity key of the AP. The identity key may be used along with a specific string and the current address2 of the AP to derive an identity hash. When receiving the identity hash in the privacy beacon, a station may use its stored identity keys along with the received address2 value to find which AP the privacy beacon is coming from. This way, only the station that has an identity key for a BPE AP may be able to read and decipher the privacy beacon.

As the station learns of the epoch of the AP, the privacy may become trivial once the AP is identified. Pre-provisioning a station with identity keys of APs of interest may not be efficient. In addition, it may not be scalable for new and public places, and may only be viable for small private networks (for example, an AP in a private car or a virtual AP in a tethering phone). In a new venue, there may be a need for a mechanism to provide the identity keys to the station. In addition, when detecting a private beacon of an unidentified AP, a station may need to first correctly identify the identity key of that AP before being able to establish a dialogue and an association to that AP. However, the station may potentially store hundreds of identity keys corresponding all the APs that it may have encountered. Parsing through all these identity keys sequentially may not be practical. Thus, there may be need for a process for a station to receive identity keys. The disclosure may provide processes for a station to receive identity keys of APs of interest. That is, the disclosure may provide processes to distribute identity keys of APs in large venues.

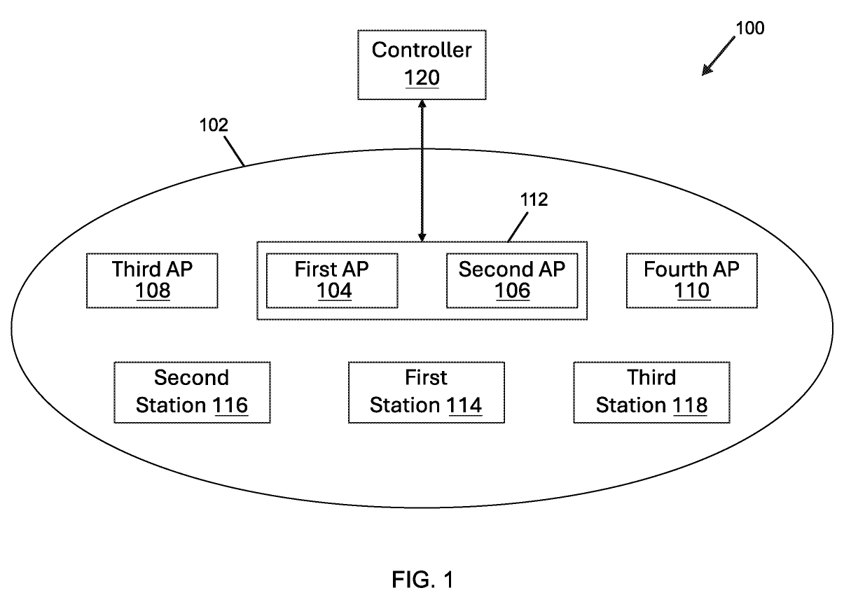

FIG. 1 is a block diagram of an operating environment 100 for identity key distribution in large networks. Operating environment 100 may include an Extended Service Set (ESS) 102. ESS 102 may include a plurality of APs, for example, a first AP 104, a second AP 106, a third AP 108, and a fourth AP 110. First AP 104 and second AP 106 may be neighboring APs or form a subset of APs 112. ESS 102 may further include a plurality of stations, for example, a first station 114, a second station 116, and a third station 118. Operating environment 100 may further include a controller 120.

The plurality of APs (including first AP 104, second AP 106, third AP 108, and fourth AP 110) may enable the plurality of stations to connect to a network for example, but is not limited to, a Wireless Local Area Network (WLAN) that may provide wireless network access (e.g., access to the WLAN for the plruality of stations as they move within the network). Each of first station 114, second station 116, and third station 118 may be any client device that connects to the network to communicate with other devices on the network. In some examples, first station 114, second station 116, and third station 118 may be but are not limited to, a smart phone, a Head Mounted Device (HMD), a mice, a keyboard, a personal computer, a tablet device, a mobile device, a telephone, a remote control device, a set-top box, a digital video recorder, an Internet-of-Things (IoT) device, a network computer, a router, Augmented Reality (AR)/Virtual Reality (VR)/XR devices, or other similar microcomputer-based device.

Controller 120 may be any network controller (e.g., a WLAN controller) and may manage first AP 104, second AP 106, third AP 108, and fourth AP 110, and/or other network devices to allow wireless devices such as first station 114, second station 116, and third station 118 to connect to the network. Controller 120 may comprise a Wireless Local Area Network (LAN) Controller (WLC) and may provision and control the coverage environment (for example, a WLAN). In some implementations of the disclosure, controller 120 may be implemented by a Digital Network Architecture Center (DNAC) controller (i.e., a Software-Defined Network (SDN) controller.

Each of the plurality of APs and the plurality of STAs may be compatible with specification standards such as, but not limited to, the Institute of Electrical and Electronics Engineer (IEEE) 802.11 specification standard for example. The plurality of APs and the plurality of STAs of operating environment 100 may use Multi-Link Operation (MLO) where they simultaneously transmit and receive across different bands and channels by establishing two or more links to two or more AP radios. These bands may comprise, but are not limited to the 2.4 GHz band, the 5 GHz band, the 6 GHz band, and the 60 GHz band. Operating environment 100 is an example configuration and there may be a different number of BSSs, STAs, APs, controllers, and/or other devices in further examples.

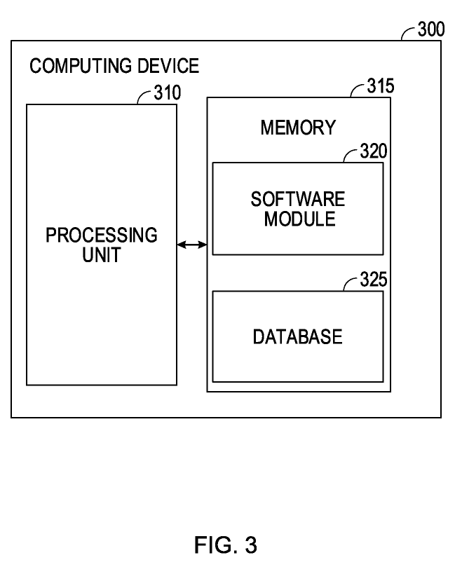

The elements described above of operating environment 100 (e.g., first AP 104, second AP 106, third AP 108, fourth AP 110, first station 114, second station 116, third station 118, and controller 120) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

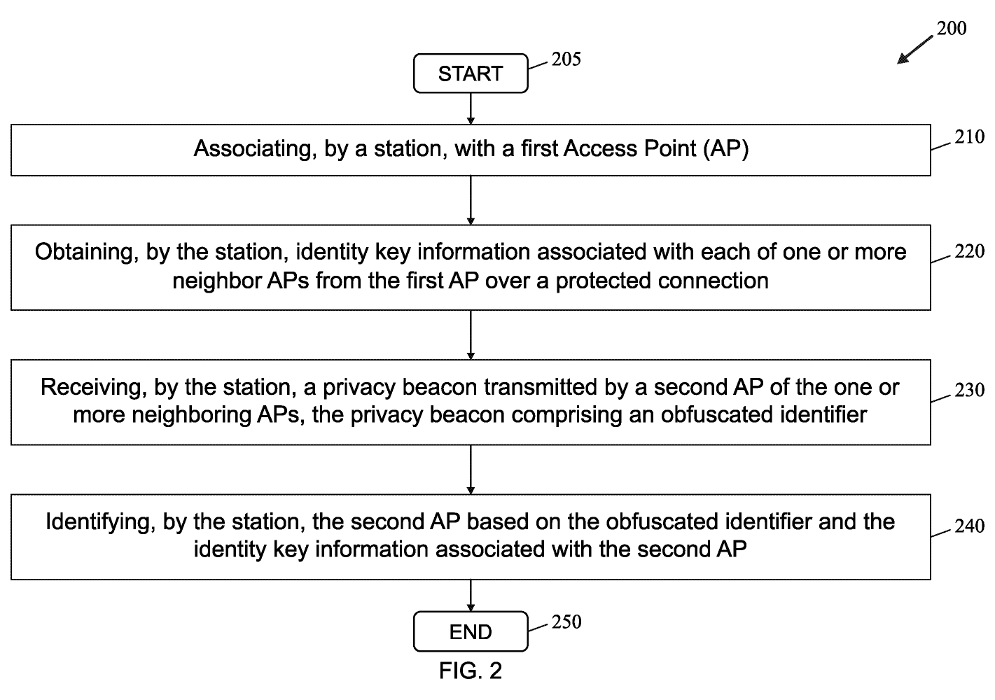

FIG. 2 is a flow chart setting forth the general stages involved in a method 200 consistent with implementations of the disclosure for identity key distribution in large networks. Method 200 may be implemented using any of the plurality of stations (that is, first station 114, second station 116, and third station 118) as described in more detail above with respect to FIG. 1. Ways to implement the stages of method 200 will be described in greater detail below. Method 200 is being described with respect to first station 114 and first AP 104, however it may be performed using any of the plurality of stations, the plurality of APs, and controller 120.

Method 200 may begin at starting block 205 and proceed to stage 210 where first station 114 may associate with first AP 104. In one example, first station 114 may associate with first AP 104 as first AP 104 may be a legacy AP (that is, a non-BPE enabled AP) or be known to first station 114. That is, first station 114 may have an identity key for first AP 104 and may associate with first AP 104 using the stored identity key.

After associating with first AP 104 at stage 210, method 200 may proceed to stage 220 where first station 114 may obtain identity key information associated with each of one or more neighbor APs from first AP 104 over a protected connection. For example, after associating with first AP 104, first station 114 may establish a secured or protected connection with first AP 104. First AP 104 then may share the identity key information associated with one or more neighbor APs over the established protected connection. The identity key information may have a limited lifetime. The lifetime value for the identity key (in the form of expiration date/time) may be shared along with the identity key.

In a first example implementation, the identity key may be common to all APs (that is, first AP 104, second AP 106, third AP 108, fourth AP 110) in ESS 102. In such implementation, the identity key may be associated with a Service Set Identifier (SSID) announced by first AP 104. First station 114 that has never associated to a BPE AP in this network thus may fetch the identity key in its store associated to the SSID. That is, first station 114 that may never have been associated to this network may join a legacy AP (that is, first AP 104). First station 114 then may request through a robust action frame from first AP 104 the identity key. First station 114 may then store the identity key along with a profile for the SSID, and use this identity key to decipher the privacy beacons of neighboring BPE APs of that ESS

In a second example implementation, the identity key may be unique to each AP in ESS 102 or may be common to a small subset of APs, for example, nearby neighbors). In the second example implementation, first station 114 may associate to first AP 104 (that is, a legacy AP). First station 114 may request a BSS Transition Management (BTM) frame or an IEEE 802.11k neighbor report from first AP 104 over the protected connection. The BTM frame or the IEEE 802.11k neighbor report, in addition to neighboring AP's BSSIDs, may also include the security key for each provided BSSID value. In addition, the IEEE 802.11k neighbor report may include a current epoch BSSID and next epoch BSSID. Both these epoch may share the same identity key.

In addition, first station 114 may also request from first AP 104 the identity keys of neighboring APs. In this implementation, the request may either be a BTM frame or an IEE 802.11k neighbor report. When the request is an IEEE 802.11k neighbor report, in a first example, a type may be set to BPE AP MLD discovery. In this first example, the neighbor report may include the BSSID and the identity key of each neighbor of interest, and may also include communication parameters allowing first station 114 to learn to communicate with that AP (e.g. modulations supported, etc.). In a second example, the type may also be set to a BPE AP MLD identity key discovery. In this second example, the neighbor report may only include the BSSID, the channels, and the identity key of each neighbor of interest. The second example mode may be likely preferred in ESS 102 where all neighboring APs may be expected to operate along the same parameters.

In a third example implementation, the identity key may not figure directly be provided inside the protected frames sent to first station 114. Rather, the identity key for an AP may need to be constructed algorithmically. In one example, the identity key of an AP may be constructed through an algorithm that may process a Pairwise Master Key (PMK) or a Pairwise Security Key (PSK) of the network and a predefined value. The predefined value may be provided in the BTM frame or the IEEE 802.11K neighbor report frame and first station 114 may construct, for each AP, the identity key by applying the algorithm to the predefined value it received with the PMK or PSK that it already may have. The same process may apply to an IEEE 802.1x based network, with a variation that the predefined value, when common to all APs in ESS 102, may be returned from a Remote Authentication Dial-In User Service (RADIUS) server instead of being provided by first AP 104.

Once having obtained the identity key information associated with each of one or more neighbor APs from first AP 104 over the protected connection at stage 220, method 200 may proceed to stage 230 where first station 114 may receive a privacy beacon transmitted by second AP 106 of the one or more neighboring APs. The privacy beacon may include an obfuscated identifier. In some examples, second AP 106 may be BPE enabled AP, and hence mat transmit privacy beacons that may be protected or obfuscated.

After receiving the privacy beacon transmitted by second AP 106 of the one or more neighboring APs, at stage 230, method 200 proceeds to stage 240 where first station 114 may identify second AP 106 based on the obfuscated identifier and the identity key information associated with second AP 104. Once having identified second AP 106 based on the obfuscated identifier and the identity key information associated with second AP 106 at stage 240, method 200 may terminate at end block 250.

The above discussed second example implementation may allow first station 114 that may already have the identity key of first AP 104 in ESS 102 to receive the identity keys of APs near first AP 104 to which it is associated. Thus, when detecting a nearby privacy beacon, first station 114 may only need to search from within the set of identity keys that it received from its current legacy or a BPE AP. This may expedite the discovery of AP’s identity associated with a received beacon, even if some time has elapsed since first station 114 may have received the BTM frame or the IEEE 802.11K neighbor report from first AP 104, and if the neighboring AP's MAC address, thus address2, has changed in between. This way, the disclosed process may anchor the identity key to a location as first station 114 may only need to fetch the local neighbors list from first AP 104 (or a current AP) instead of searching through its entire database of identity keys each time.

In another implementation, the identity keys, BSSIDs, and channels of the neighbor APs or subset of APs of ESS 102 may be shared with an out-of-band mechanism by first AP 104 with first station 114. In a public venue, first AP 102 may create a dynamic Near Field Communication (NFC) code encoding the identity keys, BSSIDs, and channels of neighbor APs or subset of APs. First station 114 may use the NFC code to retrieve it by tapping a NFC dynamic tag that is placed at a registration desk or a location accessible only to authorized users. Similarly, in another implementation, first AP 104 may generate a Quick Response (QR) code that may allow downloading the identity keys, the BSSIDs, and the channels of the neighbor APs of first AP 104 or a subset of APs of ESS 102.

In another implementation, a user or first station 114 may use a web portal to register to a venue. The registration may include proving the user’s identity or a proof of authorization to use the network in any form. The identity keys, BSSIDs, and operating channels may then made available by the web portal. In yet another implementation, the user may register a cellular number and may receive the identity keys, BSSIDs, and operating channels by a Short Message Service (SMS) or a link where it can be downloaded. In a variation, the user may use an application to perform the same operation as the web portal. In another implementation, the identity key may only be provided to stations if they prove that they are close to first AP 104, via Fine Time Measurement (FTM) or any other ranging mechanisms, thereby performing secure distance-bounding.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for identity key distribution in large networks as described above with respect to FIG. 2. Computing device 300, for example, may provide an operating environment for first AP 104, second AP 106, third AP 108, fourth AP 110, first station 114, second station 116, third station 118, and controller 120. First AP 104, second AP 106, third AP 108, fourth AP 110, first station 114, second station 116, third station 118, and controller 120 may operate in other environments and are not limited to computing device 300.

Computing device 300 may be implemented using a Wi-Fi AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Implementations of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, implementations of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a Random Access Memory (RAM), a Read-only Memory (ROM), an Erasable Programmable Read-only Memory (EPROM or Flash memory), an optical fiber, and a portable Compact Disc Read-only Memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain implementations of the disclosure have been described, other implementations may exist. Furthermore, although implementations of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, implementations of the disclosure may be practiced in an electrical circuit comprising discrete electronic elements, packaged or integrated electronic chips containing logic gates, a circuit utilizing a microprocessor, or on a single chip containing electronic elements or microprocessors. Implementations of the disclosure may also be practiced using other technologies capable of performing logical operations such as, for example, AND, OR, and NOT, including but not limited to, mechanical, optical, fluidic, and quantum technologies. In addition, implementations of the disclosure may be practiced within a general purpose computer or in any other circuits or systems.

Implementations of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to implementations of the disclosure, may be performed via application-specific logic integrated with other components of computing device 300 on the single integrated circuit (chip).

Implementations of the present disclosure, for example, are described above with reference to block diagrams and/or operational illustrations of methods, systems, and computer program products according to implementations of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as example for implementations of the disclosure.

What is claimed is:

1. A method comprising:
associating, by a station, with a first Access Point (AP);
obtaining, by the station, identity key information associated with each of one or more neighbor APs from the first AP over a protected connection;
receiving, by the station, a privacy beacon transmitted by a second AP of the one or more neighboring APs, the privacy beacon comprising an obfuscated identifier; and
identifying, by the station, the second AP based on the obfuscated identifier and the identity key information associated with the second AP.

2. The method of claim 1, wherein the identity key information comprises an identity key and a Service Set Identifier (SSID).

3. The method of claim 1, wherein obtaining the identity key information comprises:
obtaining the identity key information through a Basic Service Set (BSS) Transition Management (BTM) frame.

4. The method of claim 1, wherein obtaining the identity key information comprises:
obtaining the identity key information through a neighbor report frame.

5. The method of claim 1, further comprising:
deriving an identity key from the identity key information, wherein deriving the identity key comprises deriving the identity key based on a Pairwise Master Key (PMK) and a key value received in the identity key information.

6. The method of claim 1, wherein the second AP is a Basic Service Set (BSS) BSS Privacy Enhancement (BPE) enabled AP.

7. The method of claim 1, wherein the identity key information is associated with a limited lifetime, and wherein the limited lifetime is obtained in the identity key information.

8. A system comprising:
a memory storage; and
a processing unit coupled to the memory storage, wherein the processing unit is operative to:
obtain identity key information associated with each of one or more Access Points (APs) of a network;
receive a privacy beacon transmitted by an AP of the network, the privacy beacon comprising an obfuscated identifier; and
identify the AP based on the obfuscated identifier and the identity key information associated with the one or more APs.

9. The system of claim 8, wherein the identity key information comprises an identity key and a Service Set Identifier (SSID).

10. The system of claim 9, wherein the processing unit being operative to obtain the identity key information comprises the processing unit being operative to:
obtain the identity key information through a Basic Service Set (BSS) Transition Management (BTM) frame.

11. The system of claim 10, wherein the processing unit being operative to obtain the identity key information comprises the processing unit being operative to:
obtain the identity key information through a neighbor report frame.

12. The system of claim 8, wherein the processing unit being operative to obtain the identity key information comprises the processing unit being operative to:
obtain the identity key information through one of: a Near Field Communication (NFC) code, a Quick response (QR) code, a web portal, a Short Service Message (SMS), an application.

13. The system of claim 8, wherein the AP is a Basic Service Set (BSS) BSS Privacy Enhancement (BPE) enabled AP.

14. The system of claim 8, wherein the identity key information is associated with a limited lifetime, and wherein the limited lifetime is obtained in the identity key information.

15. A non-transitory computer-readable storage medium that stores a set of instructions which when executed perform a method executed by the set of instructions comprising:
associating, by a station, with a first Access Point (AP);
obtaining, by the station, identity key information associated with each of one or more neighbor APs from the first AP over a protected connection;
receiving, by the station, a privacy beacon transmitted by a second AP of the one or more neighboring APs, the privacy beacon comprising an obfuscated identifier; and
identifying, by the station, the second AP based on the obfuscated identifier and the identity key information associated with the second AP.

16. The non-transitory computer-readable storage medium of claim 15, wherein obtaining the identity key information comprises:
obtaining the identity key information through a Basic Service Set (BSS) Transition Management (BTM) frame.

17. The non-transitory computer-readable storage medium of claim 16, wherein obtaining the identity key information comprises:
obtaining the identity key information through a neighbor report frame.

18. The non-transitory computer-readable storage medium of claim 17, wherein the first AP is a non- Basic Service Set (BSS) BSS Privacy Enhancement (BPE) enabled AP.

19. The non-transitory computer-readable storage medium of claim 15, wherein the second AP is a Basic Service Set (BSS) BSS Privacy Enhancement (BPE) enabled AP.

20. The non-transitory computer-readable storage medium of claim 15, wherein the identity key information is associated with a limited lifetime, and wherein the limited lifetime is obtained in the identity key information.
